(19) United States
(12) Patent Application Publication
(10) Pub. No.: US 2006/0046176 A1
(43) Pub. Date: Mar. 2, 2006

(54) Toner for electrostatic image development

(75) Inventor: Yasuhiro Hidaka, Wakayama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KAO CORPORATION, Tokyo (JP)

(21) Appl. No.: 11/199,250

(22) Filed: Aug. 9, 2005

(30) Foreign Application Priority Data
Sep. 2, 2004 (JP) 2004-256163

(51) Int. Cl. G03G 9/08

(52) U.S. Cl. 430/108.8; 430/109.4; 430/124

(57) ABSTRACT

A toner for electrostatic image development, containing a resin binder comprising a polyester having a softening point of from 125° to 160° C.; a releasing agent containing a paraffin wax having a melting point of from 70° to 90° C. and a penetration at 25° C. of from 4 to 10, wherein the n(normal)-paraffin is contained in an amount of 82 to 92% by weight of the paraffin wax; and a colorant. The toner for electrostatic image development of the present invention can be used, for example in electrophotography, electrostatic recording method, electrostatic printing method or the like.

### FIELD OF THE INVENTION

The present invention relates to a toner for electrostatic image development used, for example, for the development of a latent image formed in electrophotography, electrostatic recording method, electrostatic printing method or the like.

### BACKGROUND OF THE INVENTION

In the trend of lowered electric power and miniaturization of full-color printers, a demand for an oil-less fixing of a full-color toner has become increasingly larger. In order to carry out the oil-less fixing in heat-and-pressure fixing, a technique in which a toner contains a low-melting point releasing agent is known. However, in order to obtain satisfactory effects in this technique, it is necessary that the toner contains a large amount of the releasing agent. As a result, various troubles caused by the use of a large amount of the releasing agent are caused in some cases, and a technique of studying the properties of the releasing agent has been proposed.

JP-B-3127323 discloses a toner containing a wax having a specified molecular weight distribution and two kinds of specified inorganic particles, wherein the toner has excellent cleanability, filming or melting adhesion thereof is not generated so that the pare-off of the photoconductor is prevented, and has excellent durability and developability.

JP-A-Hei-7-287413 discloses a toner containing a paraffin wax having an endothermic peak within a specified temperature range as determined by a differential scanning calorimetry (DSC), wherein the toner has excellent fixing strength even at a low fixing temperature.

JP 2000-321815 A discloses a toner containing a wax containing 92% by mass or more of n-paraffin of the wax, wherein the wax has a peak top of the maximum endothermic peak as determined by DSC within a specified temperature range, wherein the toner has excellent fixing ability, storage stability, fluidity and melt-adhesion resistance.

### SUMMARY OF THE INVENTION

The present invention relates to a toner for electrostatic image development, containing:
a resin binder containing a polyester having a softening point of from 125° to 160° C.;
a releasing agent containing a paraffin wax having a melting point of from 70° to 90° C. and a penetration at 25° C. of from 4 to 10, wherein the n(normal)-paraffin is contained in an amount of 82 to 92% by weight of the paraffin wax; and
a colorant.

### DETAILED DESCRIPTION OF THE INVENTION

The present invention relates to a toner for electrostatic image development having a wide fixable temperature range and excellent filming resistance even when the toner is used for an oil-less fixing type image-forming apparatus.

The toner for electrostatic image development of the present invention exhibits excellent effects that the toner has a wide fixable temperature range and excellent filming resistance even when the toner is used for an oil-less fixing type image-forming apparatus.

These and other advantages of the present invention will be apparent from the following description.

The polyester has the features of excellent transparency and durability as a resin binder. Therefore, the present inventors have tried to develop a toner having more improved oil-less fixing ability and filming resistance by studying the combination of a polyester with a specified releasing agent.

In order to improve the fixing ability of the toner containing the polyester, an ester wax such as carnauba wax has been used because of its excellent dispersibility in the polyester and excellent durability. However, there are some cases where it is difficult to widen the fixable temperature range because the ester wax in the polyester is too well dispersed, so that the ester wax is less likely to be exposed to the surface during fixing due to excessive dispersion. In addition, there is a likelihood that a large amount of the ester wax must be contained in the toner in order to obtain a satisfactory oil-less fixing ability. The fact that the wax itself is rigid in addition to its excessive dispersion is considered as one of the causative factors therefor.

On the other hand, in a hydrocarbon-based wax, such as a synthetic hydrocarbon-based wax or a petroleum wax, which is less likely to be dispersed in the polyester, the wax generally has too large particle size of dispersed particles in the toner, so that the wax gives significant effects in the fixing ability but has poor stability with time during durability printing, so that it is very difficult to use a toner containing a polyester as a resin binder. One of the factors for the unfavorable stability with time is considered to be caused by a soft wax itself besides the particle size of the dispersed particles.

Therefore, studies have been made by remarking on the appropriate dispersibility (affinity) of the releasing agent in (to) the polyester and the rigidness of the releasing agent. Especially, the studies have been made on durability by remarking on a hydrocarbon-based wax from the viewpoint of fixing ability. As a result, by combining a paraffin wax having specified melting point and penetration, and containing n-paraffin in a specified amount with a polyester, a wax having an appropriate rigidness is excellently dispersed in the resin, so that fixing ability and filming resistance of a toner containing the polyester having a specified softening point as a resin binder can be improved.

In the present invention, the resin binder contains a polyester having a specified softening point from the viewpoint of improving dispersibility of n-paraffin wax described below and improving durability. The polyester has a softening point of from 125° to 160° C., preferably from 130° to 160° C., more preferably from 135° to 150° C. The softening point is 125° C. or more in order to prevent the worsening of the kneading strength during kneading and the lowering of the dispersion of the wax in the toner, and the softening point is 160° C. or less from the viewpoint of fixing ability.

The polyester having the specified softening point as mentioned above is contained in the resin binder in an amount of preferably from 50 to 100% by weight, more preferably from 80 to 100% by weight, even more preferably substantially 100% by weight. Here, the resin binder may properly contain a resin such as a styrene-acrylic resin, an epoxy resin, a polycarbonate, or a polyurethane; or a polyester other than the polyester having the specified softening point as mentioned above.

As the raw material monomers for the polyester, a known dihydric or higher polyhydric alcohol component, and a known carboxylic acid component containing dicarboxylic or higher polycarboxylic acids, acid anhydrides thereof and esters thereof.

It is preferable that the alcohol component contains a compound represented by the formula (I): 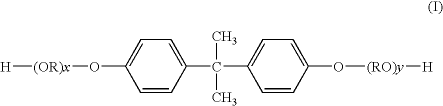
wherein R is an alkylene group having 2 or 3 carbon atoms, and x and y are positive numbers, wherein a sum of x and y is from 1 to 16, preferably from 1.5 to 5.0.

The compound represented by the formula (I) includes alkylene(2 to 3 carbon atoms) oxide(average number of moles: 1 to 16) adducts of bisphenol A such as polyoxypropylene(2.2)-2,2-bis(4-hydroxyphenyl)propane and polyoxyethylene(2.0)-2,2-bis(4-hydroxyphenyl)propane, and the like. In addition, other alcohol component includes ethylene glycol, propylene glycol, glycerol, pentaerythritol, trimethylolpropane, hydrogenated bisphenol A, sorbitol, alkylene(2 to 4 carbon atoms) oxide(average number of moles: 1 to 16) adducts thereof, and the like.

The compound represented by the formula (I) is contained in an amount of preferably 5% by mol or more, more preferably 50% by mol or more, even more preferably 100% by mol of the alcohol component.

In addition, the carboxylic acid component includes dicarboxylic acids such as phthalic acid, isophthalic acid, terephthalic acid, fumaric acid, maleic acid, a substituted succinic acid of which substituent is an alkyl group having 1 to 20 carbon atoms or an alkenyl group having 2 to 20 carbon atoms, such as dodecenylsuccinic acid or octylsuccinic acid; and tricarboxylic or higher polycarboxylic acids such as 1,2,4-benzenetricarboxylic acid (trimellitic acid) and pyromellitic acid; acid anhydrides thereof, alkyl (1 to 3 carbon atoms) esters thereof, and the like.

The polyester can be prepared by, for example, polycondensation of the alcohol component and the carboxylic acid component or the like at a temperature of from 180° to 250° C. in an inert gas atmosphere, in the presence of an esterification catalyst as desired. The polyester having the desired softening point can be obtained by adjusting the reaction time, the reaction temperature and the like during the production.

It is preferable that the polyester has an acid value of from 1 to 40 mg KOH/g, a hydroxyl group of from 3 to 60 mg KOH/g, and a glass transition temperature of from 50° to 75° C., respectively.

The releasing agent in the present invention is one that contains a paraffin wax having specified melting point and penetration, and containing n-paraffin in a specified amount. In the present invention, the paraffin wax refers to a paraffin wax as prescribed in JIS K2235. In addition, the paraffin wax may be obtained from any of coals or petroleum as raw materials, and in the present invention, a paraffin wax obtained by purifying a petroleum is preferable from the viewpoint of fixing ability. The paraffin wax obtained by purifying a petroleum includes, for example, a high-purity purified paraffin wax obtained by further subjecting a petroleum wax extracted from a petroleum to separation and purification with a vacuum distillation distilled oil, thereby increasing the ratio of a linear hydrocarbon. In addition, the paraffin wax using a coal as a raw material includes Fischer-Tropsch wax obtained by hydrogenating a distillated component obtained as a by-product in the manufacture of the synthetic petroleum according to Fischer-Tropsch method, thereby removing an unsaturated hydrocarbon and oxygen compound.

The paraffin wax has a melting point of from 70° to 90° C., preferably from 72° to 85° C., more preferably from 75° to 80° C. The melting point is 70° C. or more, from the viewpoint of storage stability and durability, and the melting point is 90° C. or less from the viewpoint of fixing ability.

The paraffin wax has a penetration at 25° C. of from 4 to 10, preferably from 5 to 8, more preferably from 6 to 7. The penetration is 4 or more in order to prevent the lowering of durability due to lowering of the dispersibility in the resin, and the penetration is 10 or less in order to prevent the lowering of durability because the wax is too soft. Here, the penetration is determined according to the method as prescribed in JIS K2235, 5.4.

The n-paraffin is contained in an amount of from 82 to 92% by weight, preferably from 84 to 91% by weight, more preferably from 86 to 90% by weight of the paraffin wax, in order to prevent the lowering of durability due to the lowering of the dispersibility in the resin. Here, the amount of the n-paraffin in the paraffin wax is determined by quantitative analysis according to gas chromatography. The n-paraffin is contained in an amount of 92% by weight or less, in order to prevent the lowering of the dispersibility in the polyester due to the crystallinity of the wax, and the n-paraffin is contained in an amount of 82% by weight or more, in order to prevent the lowering of the dispersibility caused by impurities.

It is preferable that the paraffin wax has one endothermic peak ascribed to melting in an endothermic curve obtained by DSC, from the viewpoint of fixing ability. In addition, the ratio of the endothermic peak temperature (Tp) to the shoulder temperature at the beginning of melting (Ts), i.e. Tp/Ts, is preferably from 1.1 to 1.3, more preferably from 1.0 to 1.2. The more the ratio of the endothermic peak temperature to the shoulder temperature at the beginning of melting approximates 1, the sharper the distribution of the molecular distribution constituting the wax, so that the distribution approximates monodistribution.

The paraffin wax is contained in an amount of preferably from 0.5 to 4 parts by weight, more preferably from 1 to 3 parts by weight, based on 100 pars by weight of the resin binder from the viewpoint of exhibition of the effects of the present invention even with the small amount of the paraffin wax, and durability.

Further, it is more preferable that the releasing agent contains an ester wax in addition to the paraffin wax from the viewpoint of fixing ability.

The ester wax includes a wax containing as a main component a fatty acid ester such as montan ester wax or castor wax, a wax obtained by partly or entirely deoxidizing a fatty acid ester such as carnauba wax, and the like. Among them, carnauba wax is preferable.

The ester wax is contained in an amount of preferably from 0.5 to 4 parts by weight, more preferably from 1 to 3 parts by weight, based on 100 pars by weight of the resin binder. The weight ratio of the paraffin wax to the ester wax (paraffin wax/ester wax) is preferably from 99/1 to 30/70, more preferably from 90/10 to 40/60. In addition, a total content of the paraffin wax and the ester wax is preferably from 50 to 100% by weight, more preferably from 70 to 100% by weight, even more preferably from 90 to 100% by weight of the releasing agent.

Further, a wax other than the paraffin wax and the ester wax may be contained as a releasing agent. The total content of the releasing agent in the toner is preferably from 0.1 to 10 parts by weight, more preferably from 1 to 5 parts by weight, based on 100 parts by weight of the resin binder.

As the colorant in the present invention, all of the dyes and pigments which are used as colorants for a toner can be used, and the colorant includes carbon blacks, Phthalocyanine Blue, Permanent Brown FG, Brilliant Fast Scarlet, Pigment Green B, Rhodamine-B Base, Solvent Red 49, Solvent Red 146, Solvent Blue 35, quinacridone, carmine 6B, disazoyellow, and the like. These colorants can be used alone or in admixture of two or more kinds. The toner of the present invention can be used as any of black toners, color toners, and full color toners. Since the toner of the present invention has excellent transparency, the toner can be suitably used as a color toner. The colorant is contained in an amount of preferably from 1 to 40 parts by weight, more preferably from 3 to 10 parts by weight, based on 100 parts by weight of the resin binder.

Further, the toner of the present invention may appropriately contain an additive such as a charge control agent, a fluidity improver, an electric conductivity modifier, an extender, a reinforcing filler such as a fibrous substance, an antioxidant, an anti-aging agent, or a cleanability improver. It is preferable that these additives are contained in the toner together with the resin binder, the releasing agent and the colorant.

The charge control agent includes positively chargeable charge control agents such as Nigrosine dyes, triphenylmethane-based dyes containing a tertiary amine as a side chain, quaternary ammonium salt compounds, polyamine resins and imidazole derivatives, and negatively chargeable charge control agents such as metal-containing azo dyes, copper phthalocyanine dyes, metal complexes of alkyl derivatives of salicylic acid and boron complexes of benzilic acid. The charge control agent is contained in an amount of preferably from 0.1 to 10 parts by weight, more preferably from 0.5 to 5 parts by weight, based on 100 parts by weight of the resin binder.

The process for preparing a toner for electrostatic image development may be any of conventionally known methods such as a kneading-pulverization method, an emulsion phase-inversion method, and a polymerization method. Among them, the kneading-pulverization method including the step of melting and kneading raw materials is preferable because the wax can be sufficiently dispersed in the resin binder even in an small amount, and facilitating the preparation of the toner. For instance, as a process for preparing a toner according to the kneading-pulverization method, the toner can be prepared, for example, by homogeneously mixing a resin binder, a releasing agent and a colorant, and additional additives as desired in a mixer such as a Henschel mixer or a ball-mill, thereafter melt-kneading with a closed kneader, a single-screw or twin-screw extruder or the like, cooling the product, roughly pulverizing with a hammer-mill, finely pulverizing with a fine pulverizer utilizing jet stream or the like or a mechanical pulverizer, and classifying the product to a desired particle size with a classifier utilizing gyratory stream or a classifier utilizing a Coanda effect. The volume-median particle size (D50) of the toner is preferably from 3 to 15 μm, more preferably from 5 to 10 μm. The particles having particle sizes of 5 μm or less are contained in an amount of preferably 8% by volume or less, more preferably 5% by volume or less of the toner.

The toner of the present invention may be subjected to an external addition treatment to its surface with an external additive such as fine inorganic particles of silica, alumina, titania, zirconia, tin oxide, zinc oxide or the like, or fine organic particles such as fine resin particles.

The toner for electrostatic image development of the present invention can be used in the method of forming fixed images according to an oil-less fixing method, so that fixing can be carried out in a wide temperature range and excellent filming resistance can be exhibited even when the toner is applied to an oil-less fixing type image-fixing apparatus. Here, the oil-less fixing type image-fixing apparatus includes an apparatus containing a heat roller fixing apparatus without being equipped with an oil feeding device, and the like. The oil feeding device encompasses a device having an oil tank, and a mechanism in which an oil is applied in a given amount to a heat roller surface, and a device having a mechanism in such a manner that a roller previously immersed in an oil is contacted with a heat roller, and the like.

The toner of the present invention can be used in any of development methods such as contact development, non-contact development, and cleaner-less development. In addition, the toner of the present invention can be used alone as a developer in the case where fine magnetic material powder is contained, or as a nonmagnetic monocomponent developer or as a two-component developer by mixing the toner with a carrier in the case where fine magnetic material powder is not contained. Especially, when the toner is used as a toner for nonmagnetic monocomponent development in which the load to the toner is large, the effects of the present invention can be more remarkably exhibited.

### EXAMPLES

The following examples further describe and demonstrate embodiments of the present invention. The examples are given solely for the purposes of illustration and are not to be construed as limitations of the present invention.

[Softening Point of the Resin]

The softening point refers to a temperature corresponding to ½ of the height (h) of the S-shaped curve showing the relationship between the downward movement of a plunger and temperature, namely, a temperature at which a half of the resin flows out, when measured by using a flow tester (CAPILLARY RHEOMETER “CFT-500D,” commercially available from Shimadzu Corporation) in which a 1 g sample is extruded through a nozzle having a die pore size of 1 mm and a length of 1 mm, while heating the sample so as to raise the temperature at a rate of 6° C./min and applying a load of 1.96 MPa thereto with the plunger.

[Acid Value and Hydroxyl Value of Resin]

The acid value or hydroxyl value is determined by a method according to JIS K 0070.

[Glass Transition Temperature of Resin]

The glass transition temperature is determined using a differential scanning calorimeter (“DSC 210,” commercially available from Seiko Instruments, Inc.), by raising its temperature to 200° C. and then cooling the hot sample to 0° C. at a cooling rate of 10° C./min, and thereafter measuring the sample while raising the temperature at a rate of 10° C./min. The glass transition temperature refers to the temperature of an intersection of the extension of the baseline of equal to or lower than the temperature of the maximum endothermic peak and the tangential line showing the maximum inclination between the kickoff of the peak and the top of the peak.

[Melting Point and Shoulder Temperature of Wax]

The temperature of the maximum endothermic peak of the heat of fusion by raising the temperature from 0° to 200° C. using a differential scanning calorimeter (“DSC 210,” commercially available from Seiko Instruments, Inc.) is defined as a melting point. In addition, the temperature of an intersection of the extension of the baseline of equal to or lower than the temperature of the maximum endothermic peak and the tangential line showing the maximum inclination between the kickoff of the peak and the top of the peak is defined as a shoulder temperature. When plural peaks were observed, the shoulder temperature is obtained from a peak at the lowest temperature side.

[Penetration of Wax]

The acid value or hydroxyl value is determined by a method according to JIS K 2235, 5.4.

### Resin Preparation Example 1

The amount 1890 g of polyoxypropylene(2.2)-2,2-bis(4-hydroxyphenyl)propane, 760 g of polyoxyethylene (2.0)-2,2-bis(4-hydroxyphenyl)propane, 700 g of terephthalic acid, 220 g of trimellitic acid, 240 g of dodecenylsuccinic acid and 10 g of dibutyltin oxide were mixed together with stirring, and the components were reacted at 230° C. in a nitrogen atmosphere until a point where the softening point reached 140° C., to give a resin A. The resin A had a glass transition temperature of 61° C., an acid value of 6.8 mg KOH/g, and a hydroxyl value of 36.3 mg KOH/g.

### Resin Preparation Example 2

The amount 1760 g of polyoxypropylene(2.2)-2,2-bis(4-hydroxyphenyl)propane, 700 g of polyoxyethylene (2.0)-2,2-bis(4-hydroxyphenyl)propane, 700 g of terephthalic acid, 220 g of trimellitic acid, 240 g of dodecenylsuccinic acid and 10 g of dibutyltin oxide were mixed together with stirring, and the components were reacted at 230° C. in a nitrogen atmosphere until a point where the softening point reached 116° C., to give a resin B. The resin B had a glass transition temperature of 62° C., an acid value of 10.8 mg KOH/g, and a hydroxyl value of 18.6 mg KOH/g.

### Resin Preparation Example 3

The amount 2450 g of polyoxypropylene(2.2)-2,2-bis(4-hydroxyphenyl)propane, 980 g of polyoxyethylene (2.0)-2,2-bis(4-hydroxyphenyl)propane, 940 g of terephthalic acid, 310 g of trimellitic acid, 300 g of dodecenylsuccinic acid and 10 g of dibutyltin oxide were mixed together with stirring, and the components were reacted at 230° C. in a nitrogen atmosphere until a point where the softening point reached 128° C., to give a resin C. The resin C had a glass transition temperature of 61° C., an acid value of 5.3 mg KOH/g, and a hydroxyl value of 40.5 mg KOH/g.

### Examples 1 to 6, and Comparative Examples 1 to 6

Materials containing a resin binder, a releasing agent and a charge control agent listed in Table 1, and 5.0 parts by weight of a carbon black “Mogul-L” (commercially available from Cabot Corporation) were previously mixed with a Henschel mixer. Thereafter, the mixture was melt-kneaded with a twin-screw extruder, and pulverized and classified with an impact-type mill and a dispersion separator, to give a negatively chargeable toner.

Further, 1 part by weight of a hydrophobic silica “NAX-50” (commercially available from Nippon Aerosil, particle size: about 30 nm) and 0.5 parts by weight of a hydrophobic silica “RX-300” (commercially available from Nippon Aerosil, particle size: about 8 nm) were added to 100 parts by weight of the resulting toner, and the mixture was mixed with a Henschel mixer, to give a toner subjected to external addition treatment.

### Example 7

The same procedures as in Example 4 were carried out except that 5.0 parts by weight a cyan pigment “ECB-301” (commercially available from DAINICHISEIKA COLOR & CHEMICALS MFG. CO., LTD.) were used in place of the carbon black, to give a toner.

### Test Example 1

### Fixing Ability

A toner was loaded to a modified apparatus, and the amount of toner adhesion on paper was determined while changing a bias voltage. Images were fixed according to an oil-less fixing method using an external fixing device in which the fixing device of a nonmagnetic monocomponent developer device “MICROLINE 3050c” (trade name, commercially available from Oki Data Corporation) was modified, while increasing the fixing temperature from 100° to 200° C. in an increment of 5° C.

The generation of offset was visually observed. Also, a fixing ratio was obtained by sticking a cellophane adhesive tape over the fixed images obtained at each fixing temperature, passing the taped fixed images through a fixing device at 40° C., peeling off the tape, and obtaining a ratio of image densities before sticking and after peeling (after tape peeling/before tape sticking×100). The temperature range at which the fixing ratio is 80% or more and no offset is generated is defined as a fixable range. The fixing ability was evaluated according to the following evaluation criteria. The results are shown in Table 1.

[Evaluation Criteria]

⊚: The fixable range is 70° C. or more.
◯: The fixable range is 40° C. or more and less than 70° C.
X: The fixable range is less than 40° C.

### Test Example 2

### Filming Resistance

A toner was loaded to a modified apparatus of a nonmagnetic monocomponent developer device “MICROLINE 3010cW” (trade name, commercially available from Oki Data Corporation). Fixed images having a printing ratio of 5% were printed continuously at a rate of 14 ppm (paper per minute) calculated as A4 size sheets for 20000 sheets. Thereafter, the state of filming to a photoconductor was visually observed. The filming resistance was evaluated according to the following evaluation criteria. The results are shown in Table 1.

[Evaluation Criteria]

◯: No filming is generated.

X: Filming is generated.

TABLE 1

| | | | | | | | | | | | | Toner Before | | | |
|---|---|---|---|---|---|---|---|---|---|---|---|---|---|---|---|
| | | | | | | | | | | | | External Addition | | | |
| | | | | | | | | | | | | Treatment | | | |
| | | | | | | | | | | | | | Content of | | |
| | | | | | | | | | | | | | Particles | | |
| | | | | | | | | | | Charge | | | Having | | |
| | | | Releasing Agent¹⁾ | | | | | | | Control | | Volume- | Particle | | |
| | Resin Binder | | | | | | | Number | | Agent²⁾ | | Median | Sizes of | | |
| | | parts | | Melt- | Pene- | n-Paraffin | | of Peaks | parts | | parts | Particle | 5 μm or | | Filming |
| | | by | | ing | tra- | Content | Tp/Ts | Ascribed | by | | by | Size | less (% by | Fixing | Resis- |
| | Kind | wt. | Kind | Point | tion | (% by wt.) | Ratio³⁾ | to Melting | wt. | Kind | wt. | (μm) | volume) | Ability | tance |
| Ex. | | | | | | | | | | | | | | | |
| No. | | | | | | | | | | | | | | | |
| 1 | Resin A | 100.0 | HNP-9 | 80 | 7 | 89 | 1.2 | 1 | 2.0 | T-77 | 1.0 | 8.0 | 3.5 | ◯ | ⊚ |
| 2 | Resin A | 100.0 | HNP-10 | 79 | 6 | 87 | 1.2 | 1 | 2.0 | T-77 | 1.0 | 8.1 | 3.3 | ◯ | ⊚ |
| 3 | Resin A | 100.0 | HNP-9 | 80 | 7 | 89 | 1.2 | 1 | 2.0 | T-77 | 1.0 | 8.1 | 3.8 | ⊚ | ⊚ |
| | | | Carnauba | — | — | — | — | — | 2.0 | | | | | | |
| | | | Wax | | | | | | | | | | | | |
| 4 | Resin A | 100.0 | HNP-9 | 80 | 7 | 89 | 1.2 | 1 | 2.0 | E-84 | 1.0 | 8.0 | 3.5 | ◯ | ⊚ |
| 5 | Resin A | 100.0 | HNP-9 | 80 | 7 | 89 | 1.2 | 1 | 5.0 | T-77 | 1.0 | 7.9 | 4.6 | ⊚ | ◯ |
| 6 | Resin C | 100.0 | HNP-9 | 80 | 7 | 89 | 1.2 | 1 | 2.0 | T-77 | 1.0 | 8.2 | 3.2 | ◯ | ◯ |
| 7 | Resin A | 100.0 | HNP-9 | 80 | 7 | 89 | 1.2 | 1 | 2.0 | E-84 | 1.0 | 8.0 | 3.6 | ◯ | ⊚ |
| Comp. | | | | | | | | | | | | | | | |
| Ex. | | | | | | | | | | | | | | | |
| No. | | | | | | | | | | | | | | | |
| 1 | Resin A | 100.0 | FT-100 | 93 | 1 | 93 | 1.5 | 1 | 2.0 | T-77 | 1.0 | 8.0 | 3.8 | X | X |
| 2 | Resin A | 100.0 | HNP-51 | 81 | 6 | 98 | 1.1 | 1 | 2.0 | T-77 | 1.0 | 7.9 | 4.0 | ◯ | X |
| 3 | Resin A | 100.0 | C-80 | 86 | 6 | 99 | 1.3 | 1 | 2.0 | T-77 | 1.0 | 8.0 | 3.4 | ◯ | X |
| 4 | Resin A | 100.0 | HNP-11 | 73 | 7 | 94 | 1.3 | 2 | 2.0 | T-77 | 1.0 | 8.0 | 3.6 | ◯ | X |
| 5 | Resin A | 100.0 | PW-155 | 72 | 15 | 71 | 1.6 | 1 | 2.0 | T-77 | 1.0 | 8.0 | 3.8 | ◯ | X |
| 6 | Resin B | 100.0 | HNP-9 | 80 | 7 | 89 | 1.2 | 1 | 2.0 | T-77 | 1.0 | 8.1 | 4.2 | ◯ | X |

¹⁾HNP-9: commercially available from Nippon Seiro, petroleum-based paraffin wax
HNP-10: commercially available from Nippon Seiro, petroleum-based paraffin wax
Carnauba Wax(Carnauba Wax C1): commercially available from Kato Yoko
FT-100: commercially available from Nippon Seiro, Fischer Tropsch wax
HNP-51: commercially available from Nippon Seiro, Fischer Tropsch wax
C-80: commercially available from Sazole, Fischer Tropsch wax
HNP-11: commercially available from Nippon Seiro, petroleum-based paraffin wax
PW-155: commercially available from Nippon Seiro, petroleum-based paraffin wax
²⁾T-77: commercially available from Hodogaya Chemical Co., Ltd., negatively chargeable charge control agent
E-84 (Bontron E-84): Orient Chemical Co., Ltd., negatively chargeable charge control agent
³⁾Tp/Ts ratio is the ratio of the endothermic peak temperature (Tp) to the shoulder temperature (Ts) at the beginning of melting. When plural endothermic peaks were observed, the peak having the largest amount of endotherm(area) is used for determination.

It can be seen from the above results that the toners of Examples containing the specified polyester and paraffin wax are excellent in both fixing ability and filming resistance, and especially have remarkable effects on durability as compared to those of the toners of Comparative Examples.

The toner for electrostatic image development of the present invention can be used, for example in electrophotography, electrostatic recording method, electrostatic printing method or the like.

The present invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A toner for electrostatic image development, comprising:
a resin binder comprising a polyester having a softening point of from 125° to 160° C.;
a releasing agent containing a paraffin wax having a melting point of from 70° to 90° C. and a penetration at 25° C. of from 4 to 10, wherein the n(normal)-paraffin is contained in an amount of 82 to 92% by weight of the paraffin wax; and
a colorant.

2. The toner according to claim 1, wherein the paraffin wax has one endothermic peak ascribed to melting in an endothermic curve determined by differential scanning calorimetry, wherein a ratio of an endothermic peak temperature to a shoulder temperature at the beginning of melting is from 1.1 to 1.3.

3. The toner according to claim 1, wherein the paraffin wax is a wax obtained by purifying a petroleum.

4. The toner according to claim 1, wherein the paraffin wax is contained in an amount of from 0.5 to 4 parts by weight, based on 100 parts by weight of the resin binder.

5. The toner according to claim 1, wherein the polyester is obtained by polycondensing an alcohol component comprising a compound represented by the formula (I): 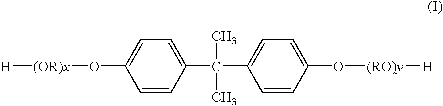
wherein R is an alkylene group having 2 or 3 carbon atoms, and x and y are positive numbers, wherein a sum of x and y is from 1 to 16, and a carboxylic acid component.

6. The toner according to claim 1, wherein the releasing agent further comprises an ester wax.

7. The toner according to claim 1, wherein the polyester is contained in an amount of from 50 to 100% by weight of the resin binder.

8. The toner according to claim 6, wherein the ester wax is carnauba wax.

9. The toner according to claim 6, wherein the ester wax is contained in an amount of from 0.5 to 4 parts by weight, based on 100 parts by weight of the resin binder.

10. The toner according to claim 6, wherein a weight ratio of the paraffin wax to the ester wax is from 99/1 to 30/70.

11. A method of forming fixed images, comprising the step of applying the toner as defined in claim 1 to an oil-less fixing-type image-fixing apparatus.
